(19) United States
(12) Patent Application Publication
(10) Pub. No.: US 2026/0029347 A1
(43) Pub. Date: Jan. 29, 2026

(54) METHOD FOR SURFACE-ENHANCED RAMAN SPECTROSCOPY IDENTIFICATION BASED ON POTENTIAL ENRICHMENT

(71) Applicant: City University of Hong Kong Matter Science Research Institute (Futian), Shenzhen (CN)

(72) Inventors: Jian LU, Shenzhen (CN); Binbin ZHOU, Shenzhen (CN); Junda SHEN, Shenzhen (CN); Jianbin LIN, Shenzhen (CN)

(21) Appl. No.: 19/020,014

(22) Filed: Jan. 14, 2025

(30) Foreign Application Priority Data
Jul. 24, 2024 (CN) 202411012008.X

(51) Int. Cl. G01N 21/65; G01N 1/40

(52) U.S. Cl. CPC G01N 21/658; G01N 1/40; G01N 2001/4038

(57) ABSTRACT

A method for surface-enhanced Raman spectroscopy identification based on potential regulation includes the following steps: S30: adding a solution to be tested to an electrolytic cell; S40: placing nanostructured substrates in the electrolytic cell to serve as an anode and a cathode, respectively; S50: adding an enhancing reagent to the solution to be tested and setting a potential; and S60: after adsorption and enrichment on the nanostructured substrate, measuring a Raman signal. The electrochemical pretreatment method for surface-enhanced Raman spectroscopy identification based on potential regulation provided herein can promote target molecules to be adsorbed onto a substrate, and enables a signal of a target peak to be amplified by ten thousand or even a million folds.

### TECHNICAL FIELD

The present disclosure relates to the technical field of surface-enhanced Raman spectroscopy, and particularly relates to a method for surface-enhanced Raman spectroscopy identification based on potential enrichment.

### BACKGROUND

Surface-enhanced Raman spectroscopy (SERS) can be used for direct detection of food due to its characteristics of high sensitivity, easy operation, no destructiveness, etc., and is expected to become a food safety diagnostic technique for determining food safety through spectrum detection.

However, despite being studied and developed for a long time, surface-enhanced Raman spectroscopy still has certain problems and challenges in actual sample detection. One of the problems in the development of surface-enhanced Raman spectroscopy is to exclude interfering substances and maximize the enrichment of target molecules on a nano-active substrate. In actual sample detection, because a sample has the characteristics of complexity of matrix components, low content of target molecules, and the like, some molecules exhibit competitive adsorption or cross-reaction with the target molecules on the substrate during detection, causing great interference in the detection results. On the other hand, due to the weak affinity of some molecules for the nano-active substrate, it is difficult to enrich the target molecules on the substrate, resulting in a weak target peak signal.

Therefore, an effective pretreatment method is needed to maximize the extraction and enrichment of the target molecules, so that the target molecules are adsorbed as much as possible onto the nano-active substrate, and thus the Raman signal intensity of the target peak is amplified by ten thousand to a million folds, which is then able to be detected by SERS.

### CONTENTS OF THE DISCLOSURE

The present disclosure aims to provide a method for surface-enhanced Raman spectroscopy identification based on potential regulation, which has the advantages of simplicity, convenience, directness, strong applicability, low cost, short time consumption, and the like, enabling direct detection by SERS after enhancement.

In order to achieve the objectives described above, according to one aspect of the present disclosure, provided is a method for surface-enhanced Raman spectroscopy identification based on potential regulation, comprising the following steps:
S30: adding a solution to be tested to an electrolytic cell;
S40: placing nanostructured substrates in the electrolytic cell to serve as an anode and a cathode, respectively;
S50: adding an enhancing reagent to the solution to be tested and setting a potential; and
S60: after adsorption and enrichment on the nanostructured substrate, measuring a Raman signal.

In a preferred embodiment of the present disclosure, the method further comprises step S10 performed before step S30:
S10: cleaning the surface-nanostructured substrates to obtain clean nanostructured substrates.

In a preferred embodiment of the present disclosure, the method further comprises step S20 performed before step S30:
S20: directly weighing the solution to be tested or performing an electrochemical pretreatment on a substance to be tested to obtain the solution to be tested.

In a preferred embodiment of the present disclosure, the method comprises the following steps:
S10: cleaning surface-nanostructured substrates to obtain clean nanostructured substrates;
S20: directly weighing the solution to be tested or performing an electrochemical pretreatment on a substance to be tested to obtain the solution to be tested;
S30: adding the solution to be tested to the electrolytic cell;
S40: placing the clean nanostructured substrates in the electrolytic cell to serve as the anode and the cathode, respectively;
S50: adding the enhancing reagent to the solution to be tested and setting the potential; and
S60: after the adsorption and enrichment on the nanostructured substrate, measuring the Raman signal.

In a preferred embodiment of the present disclosure, in step S20, the method for the electrochemical pretreatment on the substance to be tested comprises: weighing the substance to be tested, adding water for immersing, adding an extractant and a salting-out agent, then performing centrifugation, and taking a supernatant to obtain the solution to be tested.

Adding an enhancing reagent to the solution to be tested is mainly for activating the nanostructured substrate and improving the detection performance.

In a preferred embodiment of the present disclosure, the substrate is made from a material selected from any one of silver, gold, copper, stainless steel, iron, glass, and quartz.

When the substrate is made from a material of stainless steel, iron, glass, or quartz, a layer of gold, silver or copper needs to be plated on the surface of the substrate to make the detection results more accurate.

The shape of the substrate is not limited in the present application, which may be sheet-like, needle-like, etc.

In the present application, the mass of the substance to be tested, the volume of the water, and the time for the immersing are not limited.

In a preferred embodiment of the present disclosure, the mass of the substance to be tested is 1-30 g; the ratio of the mass of the substance to be tested to the volume of the water is 1 g:1 mL-1 g:5 mL; the ratio of the mass of the substance to be tested to the volume of the extractant to the mass of the salting-out agent is 1 g:2 mL:0.5 g-1 g:15 mL:2 g.

Further preferably, the time for the immersing in the water is 5-30 min.

In a preferred embodiment of the present disclosure, in step S20, the extractant is selected from any one of ethyl acetate, chloroform, acetonitrile, diethyl ether, benzene, and toluene;
preferably, the salting-out agent is a sulfate and/or chloride salt, preferably one or more of magnesium sulfate, ammonium sulfate, sodium sulfate, sodium chloride, and potassium chloride.

In a preferred embodiment of the present disclosure, the centrifugation is performed under a condition of 3000-6000 rpm for 3-10 min.

In a preferred embodiment of the present disclosure, the volume of the electrolytic cell is 5-1000 mL.

In a preferred embodiment of the present disclosure, in step S30, the solution to be tested is selected from one or more of aldicarb, terbufos, phorate, diniconazole, and terbutryn solution; the substance to be tested is selected from one or more of Panaxnotoginseng (sprayed with aldicarb) and Panaxnotoginseng (sprayed with terbufos).

If the solution to be tested is one of the solutions described above, the electrochemical pretreatment may not be performed.

In a preferred embodiment of the present disclosure, in step S30, the solution to be tested is added in a volume of 1-1000 mL.

Preferably, in step S40, the substrates are placed to a depth of 0.5-8 cm in the solution to be tested.

Controlling the depth of the substrate in the solution to be tested within the range described above is mainly to ensure that the target molecules can be adequately adsorbed onto the nano-treated substrate; if the substrate is placed too deep in the solution to be tested, and the non-nano-treated part is immersed in the solution to be tested, then the target molecules cannot be adsorbed or are rarely adsorbed onto the non-nano-treated part, which can easily affect the test results; conversely, if the substrate is inserted too shallowly into the solution to be tested, the effective length of the substrate onto which the target molecules are adsorbed is too short, and the part of the substrate without target molecules adsorbed may be detected, thereby affecting the test results.

In one embodiment of the present disclosure, in step S50, the enhancing reagent is selected from acidic solutions, preferably one or more of nitric acid, sulfuric acid, hydrochloric acid, and carbonic acid; the concentration of the enhancing reagent is 0.01-10 mol/L, and the volume ratio of the solution to be tested to the added enhancing reagent is 1:0.01-1:0.05.

The enhancing reagent is added mainly to promote the target molecules to be adsorbed onto the substrate, so that the signal of the target peak is amplified by ten thousand or even a million folds, which can be applied to the detection of trace substances.

In a preferred embodiment of the present disclosure, in step S50, the potential is 1-5 V, and the potential is maintained for 10-1200 s.

In a preferred embodiment of the present disclosure, in step S60, the measuring approach comprises taking out the surface-nanostructured substrate and placing the same on a matched sample stage to test the Raman signal, or testing the Raman signal on the surface-nanostructured substrate through the electrolytic cell; the Raman signal is measured using laser wavelengths of 266 nm, 532 nm, 633 nm, 785 nm, 830 nm, or 1064 nm, with an integration time of 0.1-10 s.

### Beneficial Effects of Present Disclosure

The method for surface-enhanced Raman spectroscopy identification based on potential regulation provided herein adopts a pretreatment approach, particularly an electrochemical pretreatment method, which can promote target molecules to be adsorbed onto a substrate, and enables a signal of a target peak to be amplified by ten thousand or even a million folds. The method is not only simple and convenient, but also has the advantages of strong applicability, low cost, short time consumption, and the like.

### BRIEF DESCRIPTION OF THE DRAWINGS

FIG. 1 is a schematic diagram showing sample pretreatment and operation principles of the present application;

FIG. 2 is a graph showing the detection results of surface-enhanced Raman spectroscopy for silver needles directly immersed in a phorate solution (panel (a)) and in phorate solutions at different concentrations under an applied potential (panel (b));

FIG. 3 is a graph showing the detection results of surface-enhanced Raman spectroscopy for silver needles immersed in a diniconazole solution with an enhancing reagent (panel (a)) and in diniconazole solutions at different concentrations under an applied potential (panel (b));

FIG. 4 is a graph showing the detection results of surface-enhanced Raman spectroscopy for silver needles immersed in a terbutryn solution with an enhancing reagent (panel (a)) and in terbutryn solutions at different concentrations under an applied potential (panel (b));

FIG. 5 is a graph showing the detection results of surface-enhanced Raman spectroscopy for silver needles immersed in a Panaxnotoginseng solution (sprayed with aldicarb) (panel (a)) and under an applied potential (panel (b));

FIG. 6 is a graph showing the detection results of surface-enhanced Raman spectroscopy for silver needles immersed in a Panaxnotoginseng solution (sprayed with terbufos) (panel (a)) and under an applied potential (panel (b)).

### EXAMPLES

The present disclosure will be illustrated in further detail with reference to the following specific examples. It will be appreciated that the following examples are merely exemplary illustrations and explanations of the present disclosure and should not be construed as limiting the claimed scope of the present disclosure. All techniques implemented on the basis of the content described above of the present disclosure are encompassed within the claimed scope of the present disclosure.

### Example 1

(1) Surface-nanostructured silver needles were ultrasonically cleaned with clear water to obtain clean nanostructured silver needles;
(2) 10 mL of a phorate solution was added to a 20-mL electrolytic cell;
(3) two cleaned nanostructured silver needles were placed in the electrolytic cell, with the needles submerged to a depth of 1.1 cm in the solution to be tested, and two wires were used to connect the two silver needles to the anode and the cathode of an electrochemical workstation, respectively;
(4) 0.15 mL of 2 mol/L nitric acid was added to the electrolytic cell described above to serve as an enhancing reagent, the power supply of the electrochemical workstation was turned on, and the potential was set to 2 V and maintained for 180 s;
(5) after enrichment, the silver needle (cathode) was removed and placed on a matched sample stage, where it was tested under a 633 nm laser with an integration time of 5 s.

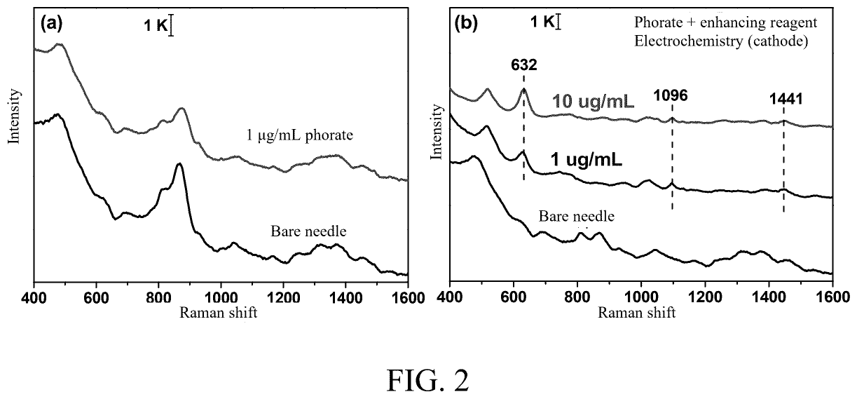

The surface-enhanced Raman spectroscopy of the phorate solution was directly tested with the silver needle, and the detection results are shown in FIG. 2 panel (a); the detection results of the surface-enhanced Raman spectroscopy of the phorate solution tested using the electrochemical method described above are shown in FIG. 2 panel (b). It can be observed that the direct testing could not detect phorate (see FIG. 2 panel (a)), but after the electrochemical pretreatment, the characteristic peaks of phorate (632 cm⁻¹, 1096 cm⁻¹, and 1441 cm⁻¹) could be detected (see FIG. 2 panel (b)).

### Example 2

(1) Surface-nanostructured silver needles were ultrasonically cleaned with clear water to obtain clean nanostructured silver needles;
(2) 7 mL of a diniconazole solution was added to a 10-mL electrolytic cell;
(3) two cleaned nanostructured silver needles were placed in the electrolytic cell, with the needles submerged to a depth of 0.7 cm in the solution to be tested, and two wires were used to connect the two silver needles to the anode and the cathode of an electrochemical workstation, respectively;
(4) 0.2 mL of 0.1 mol/L sulfuric acid was added to the electrolytic cell described above to serve as an enhancing reagent, the power supply of the electrochemical workstation was turned on, and the potential was set to 1 V and maintained for 1200 s;
(5) after enrichment, the silver needle (cathode) was removed and placed on a matched sample stage, where it was tested under a 785 nm laser with an integration time of 1 s.

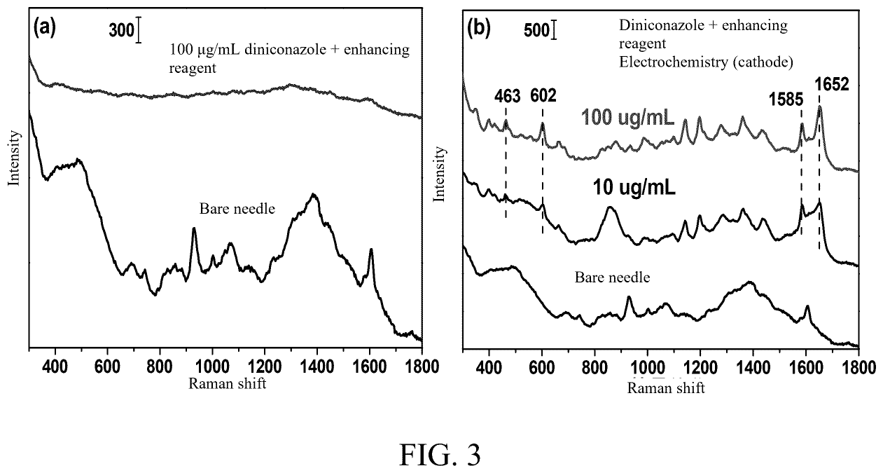

The surface-enhanced Raman spectroscopy of the diniconazole solution added with the enhancing reagent was directly tested with the silver needle, and the detection results are shown in FIG. 3 panel (a); the detection results of the surface-enhanced Raman spectroscopy of the diniconazole solution tested after the treatment by the electrochemical method described above are shown in FIG. 3 panel (b). It can be observed that the direct testing could not detect diniconazole (see FIG. 3 panel (a)), but after the electrochemical pretreatment, the characteristic peaks of diniconazole (463 cm⁻¹, 602 cm⁻¹, 1585 cm⁻¹, and 1652 cm⁻¹) could be detected (see FIG. 3 panel (b)).

### Example 3

(1) Surface-nanostructured silver needles were ultrasonically cleaned with clear water to obtain clean nanostructured silver needles;
(2) 30 mL of a terbutryn solution was added to a 50-mL electrolytic cell;
(3) two cleaned nanostructured silver needles were placed in the electrolytic cell, with the needles submerged to a depth of 2.8 cm in the solution to be tested, and two wires were used to connect the two silver needles to the anode and the cathode of an electrochemical workstation, respectively;
(4) 0.4 mL of 3 mol/L carbonic acid was added to the electrolytic cell described above to serve as an enhancing reagent, the power supply of the electrochemical workstation was turned on, and the potential was set to 1 V and maintained for 600 s;
(5) after enrichment, the Raman signal on the silver needle (cathode) was tested through the electrolytic cell under a 1064 nm laser with an integration time of 10 s.

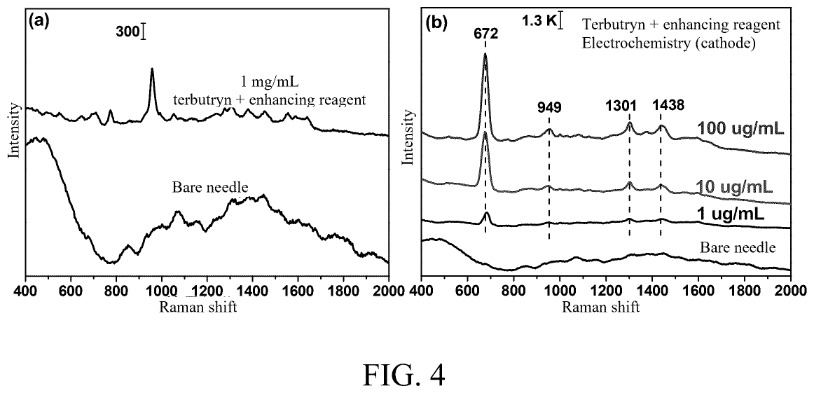

The surface-enhanced Raman spectroscopy of the terbutryn solution added with the enhancing reagent was directly tested with the silver needle, and the detection results are shown in FIG. 4 panel (a); the detection results of the surface-enhanced Raman spectroscopy of the terbutryn solution tested after the pretreatment by the electrochemical method described above are shown in FIG. 4 panel (b). It can be observed that the direct testing could not detect terbutryn (see FIG. 4 panel (a)), but after the electrochemical pretreatment, the characteristic peaks of terbutryn (672 cm⁻¹, 949 cm⁻¹, 1301 cm⁻¹, and 1438 cm⁻¹) could be detected (see FIG. 4 panel (b)).

### Example 4

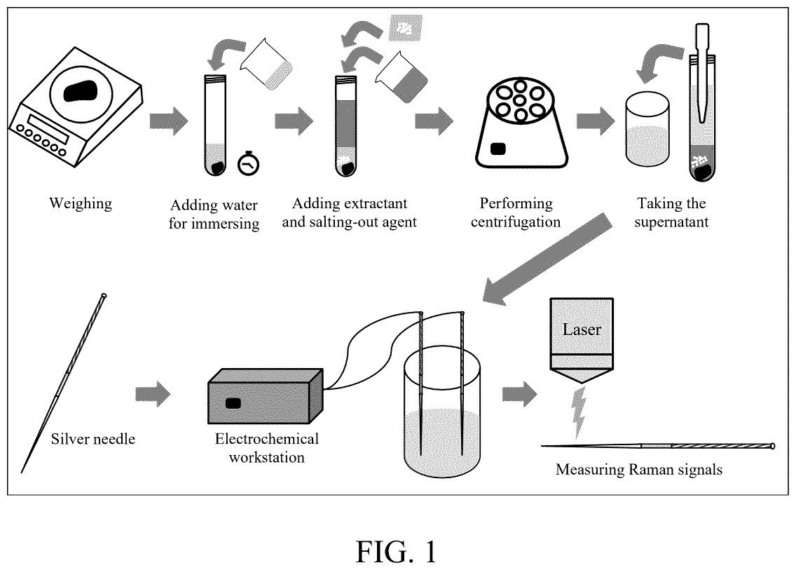

The following procedures were carried out according to FIG. 1:
(1) Surface-nanostructured silver needles were ultrasonically cleaned with clear water to obtain clean nanostructured silver needles;
(2) an 8 g sample of Panaxnotoginseng sprayed with aldicarb was weighed, added with 15 mL of water for immersing for 15 min, and then added with 30 mL of extractant toluene and 5 g of salting-out agent sodium sulfate, the resulting mixture was centrifuged at 4000 rpm for 8 min, and the supernatant was taken to obtain a solution to be tested;
(3) 8 mL of the solution to be tested described above was added to a 10 mL electrolytic cell;
(4) two cleaned nanostructured silver needles were placed in the electrolytic cell, with the needles submerged to a depth of 0.8 cm in the solution to be tested, and two wires were used to connect the two silver needles to the anode and the cathode of an electrochemical workstation, respectively;
(5) 0.25 mL of 0.1 mol/L hydrochloric acid was added to the electrolytic cell described above to serve as an enhancing reagent, the power supply of the electrochemical workstation was turned on, and the potential was set to 3 V and maintained for 180 s;
(6) after enrichment, the silver needle (anode) was removed and placed on a matched sample stage, where it was tested under a 785 nm laser with an integration time of 2 s.

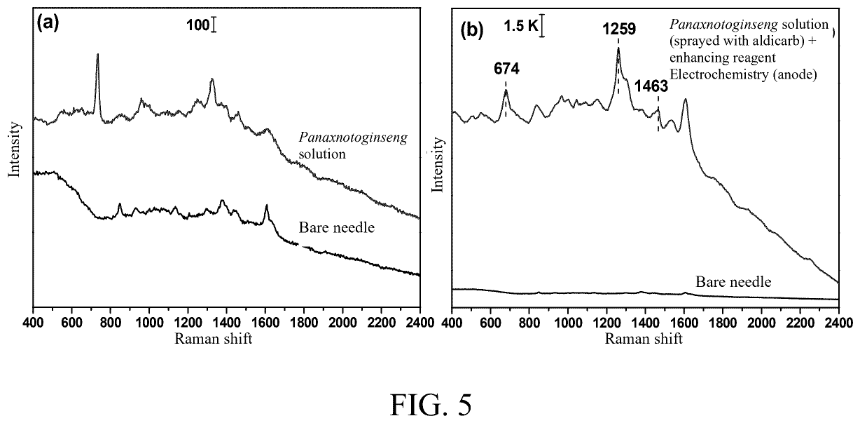

The detection results of the surface-enhanced Raman spectroscopy of the Panaxnotoginseng solution directly tested with the silver needle are shown in FIG. 5 panel (a); the detection results of the surface-enhanced Raman spectroscopy of the Panaxnotoginseng solution tested after the pretreatment by the electrochemical method described above are shown in FIG. 5 panel (b). It can be observed that the direct testing could not detect the aldicarb in Panaxnotoginseng (see FIG. 5 panel (a)), but after the electrochemical pretreatment, the characteristic peaks of the aldicarb in Panaxnotoginseng (674 cm⁻¹, 1259 cm⁻¹, and 1463 cm⁻¹) could be detected (see FIG. 5 panel (b)).

### Example 5

The following procedures were carried out according to FIG. 1:
(1) Surface-nanostructured silver needles were ultrasonically cleaned with clear water to obtain clean nanostructured silver needles;
(2) a 5 g sample of Panaxnotoginseng sprayed with terbufos was weighed, added with 10 mL of water for immersing for 25 min, and then added with 20 mL of extractant ethyl acetate and 3 g of salting-out agent magnesium sulfate, the resulting mixture was centrifuged at 5000 rpm for 6 min, and the supernatant was taken to obtain a solution to be tested;
(3) 20 mL of the solution to be tested described above was added to a 30 mL electrolytic cell;
(4) two cleaned nanostructured silver needles were placed in the electrolytic cell, with the needles submerged to a depth of 1.6 cm in the solution to be tested, and two wires were used to connect the two silver needles to the anode and the cathode of an electrochemical workstation, respectively;
(5) 0.4 mL of 1 mol/L nitric acid was added to the electrolytic cell described above to serve as an enhancing reagent, the power supply of the electrochemical workstation was turned on, and the potential was set to 1 V and maintained for 480 s;
(6) after enrichment, the Raman signal on the silver needle (anode) was tested through the electrolytic cell under a 532 nm laser with an integration time of 3 s.

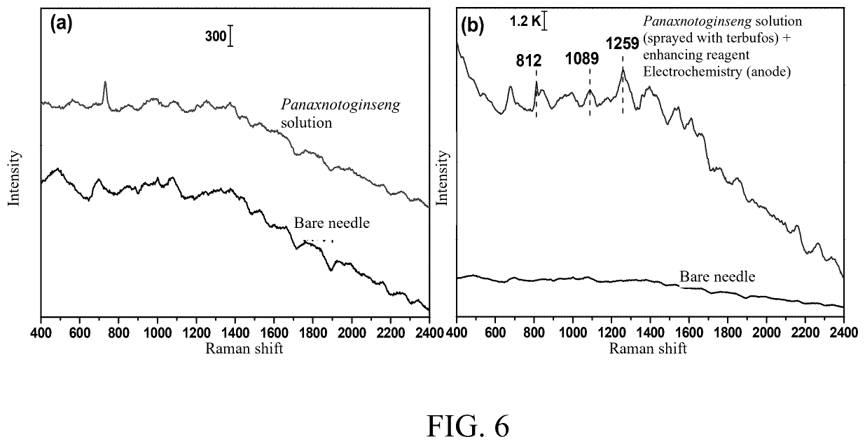

The detection results of the surface-enhanced Raman spectroscopy of the Panaxnotoginseng solution directly tested with the silver needle are shown in FIG. 6 panel (a); the detection results of the surface-enhanced Raman spectroscopy of the Panaxnotoginseng solution tested after the pretreatment by the electrochemical method described above are shown in FIG. 6 panel (b). It can be observed that the direct testing could not detect the terbufos in Panaxnotoginseng (see FIG. 6 panel (a)), but after the electrochemical pretreatment, the characteristic peaks of the terbufos in Panaxnotoginseng (812 cm⁻¹, 1089 cm⁻¹, and 1259 cm⁻¹) could be detected (see FIG. 6 panel (b)).

The embodiments of the present disclosure have been described above. However, the present disclosure is not limited to the embodiments described above. Any modification, equivalent replacement, improvement, and the like made without departing from the spirit and principle of the present disclosure shall fall within the protection scope of the present disclosure.

1. A method for surface-enhanced Raman spectroscopy identification based on potential regulation, comprising the following steps:
S30: adding a solution to be tested to an electrolytic cell;
S40: placing nanostructured substrates in the electrolytic cell to serve as an anode and a cathode, respectively;
S50: adding an enhancing reagent to the solution to be tested and setting a potential; and
S60: after adsorption and enrichment on the nanostructured substrate, measuring a Raman signal.

2. The method as claimed in claim 1, further comprising step S10 performed before step S30:
S10: cleaning surface-nanostructured substrates to obtain clean nanostructured substrates.

3. The method as claimed in claim 1, further comprising step S20 performed before step S30:
S20: directly weighing the solution to be tested or performing an electrochemical pretreatment on a substance to be tested to obtain the solution to be tested.

4. The method as claimed in claim 1, comprising the following steps:
S10: cleaning surface-nanostructured substrates to obtain clean nanostructured substrates;
S20: directly weighing the solution to be tested or performing an electrochemical pretreatment on a substance to be tested to obtain the solution to be tested;
S30: adding the solution to be tested to the electrolytic cell;
S40: placing the clean nanostructured substrates in the electrolytic cell to serve as the anode and the cathode, respectively;
S50: adding the enhancing reagent to the solution to be tested and setting the potential; and
S60: after the adsorption and enrichment on the nanostructured substrate, measuring the Raman signal.

5. The method as claimed in claim 3, wherein in step S20, the method for the electrochemical pretreatment on the substance to be tested comprises: weighing the substance to be tested, adding water for immersing, adding an extractant and a salting-out agent, then performing centrifugation, and taking a supernatant to obtain the solution to be tested.

6. The method as claimed in claim 5, wherein the substrate is made from a material selected from any one of silver, gold, copper, stainless steel, iron, glass, and quartz;
preferably, in step S20, the mass of the weighed substance to be tested is 1-30 g; the ratio of the mass of the substance to be tested to the volume of the water is 1 g:1 mL-1 g:5 mL; the ratio of the mass of the substance to be tested to the volume of the extractant to the mass of the salting-out agent is 1 g:2 mL:0.5 g-1 g:15 mL:2 g;
preferably, the time for the immersing in the water is 5-30 min.

7. The method as claimed in claim 5, wherein in step S20, the extractant is selected from any one of ethyl acetate, chloroform, acetonitrile, diethyl ether, benzene, and toluene;
preferably, the salting-out agent is a sulfate and/or chloride salt, preferably one or more of magnesium sulfate, ammonium sulfate, sodium sulfate, sodium chloride, and potassium chloride;
preferably, the centrifugation is performed under a condition of 3000-6000 rpm for 3-10 min.

8. The method as claimed in claim 1, wherein in step S30, the solution to be tested is selected from one or more of aldicarb, terbufos, phorate, diniconazole, and terbutryn solution; the substance to be tested is a sample of Panaxnotoginseng sprayed with aldicarb or sprayed with terbufos;
preferably, in step S30, the solution to be tested is added in a volume of 1-1000 mL;
preferably, in step S40, the substrates are placed to a depth of 0.5-8 cm in the solution to be tested.

9. The method as claimed in claim 1, wherein in step S50, the enhancing reagent is an acid solution, preferably one or more of nitric acid, sulfuric acid, hydrochloric acid, and carbonic acid;
the concentration of the enhancing reagent is 0.01-10 mol/L, and the volume ratio of the solution to be tested to the added enhancing reagent is 1:0.01-1:0.05;
preferably, in step S50, the potential is 1-5 V, and the potential is maintained for 10-1200 s.

10. The method as claimed in claim 1, wherein in step S60, the measuring approach comprises taking out the surface-nanostructured substrate and placing the same on a matched sample stage to test the Raman signal, or testing the Raman signal on the surface-nanostructured substrate through the electrolytic cell.
